(19) United States
(12) Patent Application Publication
(10) Pub. No.: US 2014/0031026 A1
(43) Pub. Date: Jan. 30, 2014

(54) METHOD AND DEVICE FOR PERFORMING A CLEANING PROCESS ON A PORTABLE ELECTRONIC DEVICE

(71) Applicant: Tencent Technology (Shenzhen) Company Limited, Shenzhen (CN)

(72) Inventor: Lei LONG, Shenzhen (CN)

(73) Assignee: Tencent Technology (Shenzhen) Company Limited, Shenzhen (CN)

(21) Appl. No.: 14/040,485

(22) Filed: Sep. 27, 2013

Related U.S. Application Data
(63) Continuation of application No. PCT/CN2013/080100, filed on Jul. 25, 2013.

(30) Foreign Application Priority Data
Jul. 30, 2012 (CN) 201210268074.4

(51) Int. Cl. H04W 4/00

(52) U.S. Cl. CPC H04W 4/001
USPC 455/418

(57) ABSTRACT

Methods and devices for performing a cleaning process on portable electronic devices are described. The method includes monitoring a system reaction to one or more instructions; determining that the system reaction does not satisfy predefined criteria; and, in response to determine that the system reaction does not satisfy the predefined criteria, performing a cleaning process on the portable electronic device.

### RELATED APPLICATIONS

This application is a continuation application of PCT Patent Application No. PCT/CN2013/080100, entitled “METHOD AND DEVICE FOR PERFORMING A CLEANING PROCESS ON A PORTABLE ELECTRONIC DEVICE,” filed on Jul. 25, 2013, which claims priority to Chinese Patent Application No. 201210268074.4, entitled “METHOD AND DEVICE FOR PERFORMING A CLEANING PROCESS ON A PORTABLE ELECTRONIC DEVICE,” filed on Jul. 30, 2012, both of which are incorporated by reference in their entirety.

### TECHNICAL FIELD

The present invention relates to the technical field of computers, and in particular, to a method and device of performing a cleaning process on a portable electronic device.

### BACKGROUND

Several smart phones allow programs to run in the background. Some temporary buffered files are produced during the operating process of an operating system of a smart phone, and these buffered files occupy a lot of memory space and affect the reaction speed of the smart phone.

So far, if a user feels that the system reacts too slowly when using a smart phone, the user manually accesses a user interface for closing applications and icons representing application programs running in the background. In order to accelerate the reaction speed of the smart phone, the user needs to manually close all or some of the application programs running in the background.

However, in the conventional operating systems, the user needs to close the application programs one by one manually, which increases the user's manual interaction with the smart phone and degrades the user's experience in using the smart phone.

### SUMMARY

To reduce the user's operations and improve the user's experience in using a portable electronic device (e.g., a smart phone), provided in the embodiments are methods and devices for processing an application program. The technical solution is as follows.

In some embodiments, a method for processing an application program is provided, and the method comprises: monitoring an operation instruction received by a client; and executing an optimization process on an operating system when it is monitored that the client has received an instruction to optimize the memory of the operation system.

The step of monitoring the operation instruction received by the client comprises starting a preset optimization interface, and monitoring the operation instruction received by the client on the optimization interface.

The step of executing the optimization process on the operating system comprises: invoking a command for deleting a buffered garbage in the operating system; and deleting a buffered garbage in the operating system according to the command for deleting a buffered garbage in the operating system; and/or, invoking a command for turning off an application program in the background of the operating system; and turning off an application program in the background of the operating system and a program associated with the application program according to the command for turning off an application program in the background of the operating system.

After the step of executing the optimization process on the operating system, the method further comprises: outputting the optimization result of the step of executing the optimization process on the operating system.

On the other hand, a device for processing an application program is also provided, and the device comprises: a monitoring module for monitoring an operation instruction received by a client; and an optimization module for executing an optimization process on an operating system when it is monitored that the client has received an instruction to optimize the memory of the operating system.

The monitoring module is used in particular for: starting a preset optimization interface and then monitoring the operation instruction received by the client on the optimization interface.

The optimization module comprises: a first invocation unit for invoking a command for deleting a buffered garbage in the operating system; and a deletion unit for deleting a buffered garbage in the operating system according to the command for deleting a buffered garbage in the operating system; and/or, a second invocation unit for invoking a command for turning off an application program in the background of the operating system after the deletion unit has deleted the buffered garbage in the operating system; and a turn-off unit for turning off an application program in the background of the operating system and a program associated with the application program according to the command for turning off an application program in the background of the operating system.

The device further comprises: an output module for outputting the optimization result of the step of executing the optimization process on the operating system after the optimization module executes the optimization process on the operating system.

In some embodiments, a method performed by a portable electronic device with a touch-sensitive display includes monitoring a system reaction to one or more instructions; determining that the system reaction does not satisfy predefined criteria; and, in response to determine that the system reaction does not satisfy the predefined criteria, performing a cleaning process on the portable electronic device.

In some embodiments, a portable electronic device includes one or more processors; a touch-sensitive display; memory; and one or more program modules stored in the memory and to be executed by the one or more processors, the one or more program modules further including: module for monitoring a system reaction to one or more instructions; module for determining that the system reaction does not satisfy predefined criteria; and module, in response to determine that the system reaction does not satisfy the predefined criteria, for performing a cleaning process on the portable electronic device.

In some embodiments, a portable electronic device includes a touch-sensitive display, one or more processors, and memory. The memory stores one or more programs for execution by the one or more processors. The one or more programs include instructions for monitoring a system reaction to one or more instructions; determining that the system reaction does not satisfy predefined criteria; and in response to determine that the system reaction does not satisfy the predefined criteria, performing a cleaning process on the portable electronic device.

In some embodiments, a computer readable storage medium stores one or more program modules for execution by one or more processors of a portable electronic device, the one or more program modules including instructions for monitoring a system reaction to one or more instructions; determining that the system reaction does not satisfy predefined criteria; and in response to determine that the system reaction does not satisfy the predefined criteria, performing a cleaning process on the portable electronic device. In some embodiments, the computer readable storage medium comprises a non-transitory computer readable storage medium.

The beneficial effects of the technical solution provided in the embodiments of the present invention are: monitoring an operation instruction received by a client; and executing an optimization process on the operating system when it is monitored that the client has received an instruction to optimize the memory of the operating system. There is no need for a user to delete any background application program manually, thus having the user's operations reduced and improving the user's experience in using the portable electronic device.

### DESCRIPTION OF THE DRAWINGS

In order to more clearly illustrate the technical solution in the embodiments of the present invention, the figures to be used for describing the embodiments will be outlined hereinafter, and apparently, the figures described hereinafter are merely some embodiments of the present invention, and for a person skilled in the art, other figures can be obtained according to these figures without any inventive efforts.

FIG. 1 is a flowchart of a method for processing an application program provided in accordance with some embodiments.

FIG. 2 is a flowchart of a method for processing an application program provided accordance with some embodiments.

FIG. 3 is a structural schematic diagram of a device for processing an application program provided in accordance with some embodiments.

FIG. 4 is a structural schematic diagram of a device for processing an application program provided in accordance with some embodiments.

FIGS. 5A-5B are exemplary user interfaces in accordance with some embodiments.

FIGS. 6A-6B are flow charts of an exemplary method for performing a cleaning process on a portable electronic device in accordance with some embodiments.

FIG. 7 is a block diagram of a system for implementing the method of performing a cleaning process in accordance with some embodiments.

### DETAILED DESCRIPTION

In order to make the objects, technical solutions and advantages of the present invention more clear, the embodiments of the present invention will be further described in detail in conjunction with the accompanying drawings.

### Embodiment I

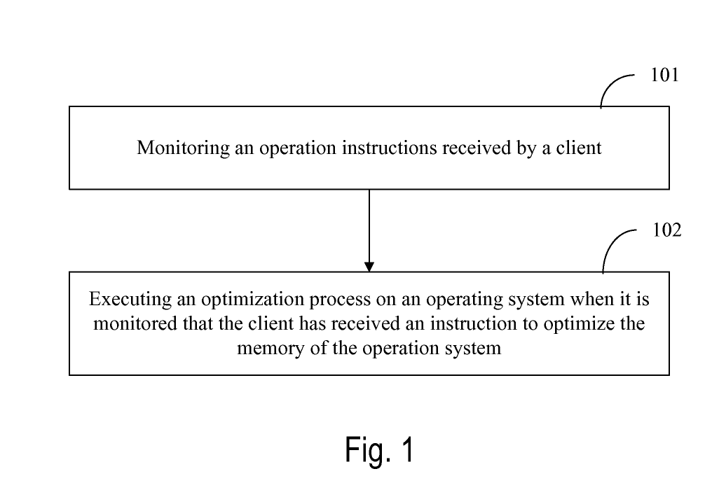

Referring to FIG. 1, a method for processing an application program is provided in this embodiment, and the method comprises: monitoring (101) an operation instruction received by a client; and executing (102) an optimization process on an operating system when it is monitored that the client has received an instruction to optimize the memory of the operating system.

The step of monitoring the operation instruction received by the client comprises: starting a preset optimization interface and then monitoring the operation instruction received by the client on the optimization interface.

The step of executing the optimization process on the operating system comprises: invoking a command for deleting a buffered garbage in the operating system; and deleting a buffered garbage in the operating system according to the command for deleting a buffered garbage in the operating system; and/or, invoking a command for turning off an application program in the background of the operating system; and turning off an application program in the background of the operating system according to the command for turning off an application program in the background of the operating system.

Optionally, after the step of executing the optimization process on the operating system, the method further comprises outputting the optimization result of the step of executing the optimization process on the operating system.

The beneficial effects of the embodiment comprise: monitoring an operation instruction received by a client; and executing an optimization process on an operating system when it is monitored that the client has received an instruction to optimize the memory of the operating system. There is no need for a user to delete any background application program manually, thus reducing the user's manual operations of the portable electronic device and improving the user's experience in using the portable electronic device.

### Embodiment II

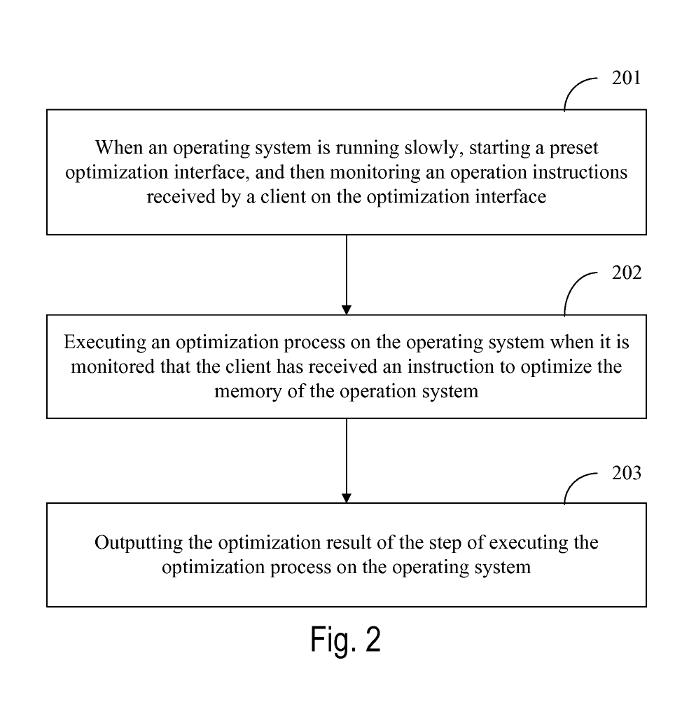

A method for processing an application program is provided in the embodiment of the present invention, and referring to FIG. 2, the flow of the method comprises, (201) when an operating system is running slowly, starting a preset optimization interface, and then monitoring an operation instruction received by a client on the optimization interface.

In this embodiment, the client is installed with a preset operating system, wherein the preset operating system comprises an operating system for a portable electronic device (e.g., a smart phone), and of course can comprise other terminal operating systems, which is not specially defined in this embodiment. Some temporary buffered files are produced by the operating system during operation in this embodiment, and these buffered files occupy a lot of memory space and affect the operation of the system. In this embodiment, an optimization system is provided for the user, so that the user can start the optimization system to pop up a preset optimization interface when the user feels that the operating system is running slowly; an optimization button is provided for the user on the optimization interface, and if the user selects this button, the system will perform an optimization process of the operating system automatically. There is no need for the user to input any commands manually (e.g., individually selecting each application program that is to be closed or files that are to be deleted), and the system can automatically execute the optimization process with just one click on the optimization button; hence, the threshold to optimize the operating system is lowered, enabling common users to optimize the operating system expediently.

In this step, when the preset optimization interface is started, the operation instruction received by the client on the optimization interface is monitored. If the operation instruction is an instruction for optimizing the operating system, then the operation system will be optimized. An optimization button is preferably provided for the user in this embodiment, which optimization button is monitored in real time, and when it is monitored that a trigger operation is performed on the optimization button, then it will be confirmed that the optimization operation instruction has been received.

What is in particular executed in step 201 is the step of monitoring the operation instruction received by the client.

Step 202 is the step of executing an optimization process on the operating system when it is monitored that the client has received an instruction to optimize the memory of the operation system.

In this step, optionally, the operating system is optimized when it is monitored that the client has received the instruction to optimize the operating system, comprises: invoking a command for deleting a buffered garbage in the operating system; and deleting a buffered garbage in the operating system according to the command for deleting a buffered garbage in the operating system; and/or invoking a command for turning off an application program in the background of the operating system; and turning off an application program in the background of the operating system according to the command for turning off an application program in the background of the operating system. Here, the buffered garbage is the temporary files produced when the operating system is running. In this embodiment, the command for deleting a buffered garbage in the operating system is set in advance, and this command is used for simulating the user's operation and deleting the buffered garbage. When the client triggers to execute system optimization, the command for deleting a buffered garbage in the operating system will be invoked, and the user's operation of clicking to delete the buffered garbage will be simulated to delete the buffered garbage in the operating system.

In this embodiment, if too many application programs or processes are running in the background, the operating speed of the operating system will be affected; so after the step of deleting the buffered garbage in the operating system, optionally, the method further comprises: invoking a command for turning off an application program in the background of the operating system; and turning off an application program in the background of the operating system according to the command for turning off an application program in the background of the operating system. Optionally, the command for turning off an application program in the background of the operating system is set in advance, which command is used for simulating the user's operation and turning off the application program running in the background and a program or process associated with the application program. When the client triggers to execute system optimization, the command for turning off an application program in the background of the operating system will be invoked, and the user's operation of turning off the application program running in the background will be simulated to turn off an application program running in the background and a program associated therewith. In particular, when the preset operating system is the iOS system, wherein SpringBoard is a primary UI process of the iOS system and all GUI programs opened in iOS are sub-processes of this process; in this embodiment, the codes of the command for turning off an application program in the background of the operating system are loaded into the SpringBoard in the form of a dynamic library, and the monitoring of an instruction of the client is added to an ingress function which loads the dynamic library, and the command for turning off an application program in the background of the operating system is used for simulating the user's GUI operation. For example, if the process to be turned off is “WeChat”, which is a sub-process of SpringBoard, in order to enable “WeChat” to run in the background, SpringBoard will give “WeChat” an ingress to the background. In this embodiment, when turning off the “WeChat” process, processes associated with SpringBoard will be turned off together, i.e. turning off the ingress to the background together to realize a complete release of “WeChat” resources.

Step 203 is the step of outputting the optimization result of the step of executing the optimization process on the operating system.

In this embodiment, after optimizing the operating system, optionally, the optimization result can be output to the preset optimization interface, enabling the user to be informed of the progress of the entire optimization process according to the optimization result, further improving the user's experience.

The beneficial effects of the embodiment comprise: monitoring an operation instruction received by a client; and executing an optimization process on the operating system when it is monitored that the client has received an instruction to optimize the memory of the operating system. There is no need for the user to delete background applications manually, thud having the user's operations reduced and the user's experience in using the portable electronic device improved.

### Embodiment III

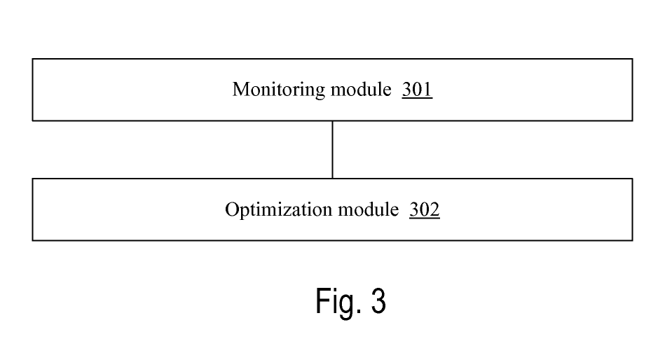

Referring to FIG. 3, the embodiments of the present invention provide a device for processing an application program, comprising: a monitoring module 301 and an optimization module 302.

The monitoring module 301 is used for monitoring an operation instruction received by a client; and the optimization module 302 is used for executing an optimization process on an operating system when it is monitored that the client has received an instruction to optimize the operating system memory.

The monitoring module is used in particular for: starting a preset optimization interface, and then monitoring the operation instruction received by the client on the optimization interface.

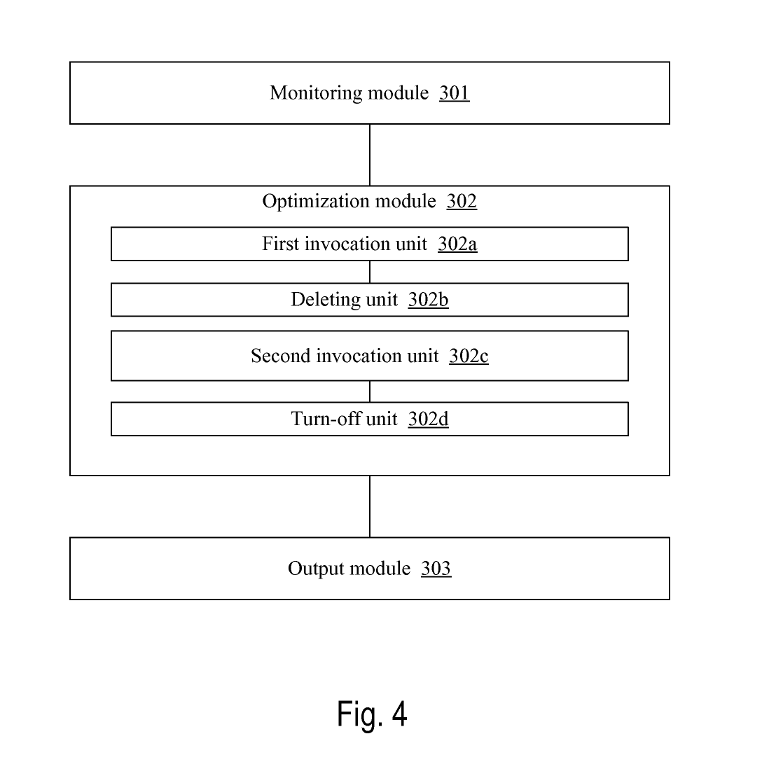

Referring to FIG. 4, the optimization module 302 comprises: a first invocation unit 302a for invoking a command for deleting a buffered garbage in the operating system; and a deletion unit 302b for deleting a buffered garbage in the operating system according to the command for deleting a buffered garbage in the operating system; and/or, a second invocation unit 302c for invoking a command for turning off an application program in the background of the operating system after the deletion unit 302b deletes the buffered garbage in the operating system; and a turn-off unit 302d for turning off an application program in the background of the operating system and a program associated with the application program according to the command for turning off an application program in the background of the operating system.

Referring to FIG. 4, optionally, the device further comprises an output module 303 for outputting the optimization result of the step of executing the optimization process on the operating system after the optimization module 302 executes the optimization process on the operating system.

The beneficial effects of the embodiment comprise: monitoring an operation instruction received by a client; and executing an optimization process on the operating system when it is monitored that the client has received an instruction to optimize the memory of the operating system. There is no need for the user to delete the background applications manually, thus having the user's operations reduced and the user's experience in using the portable electronic device improved.

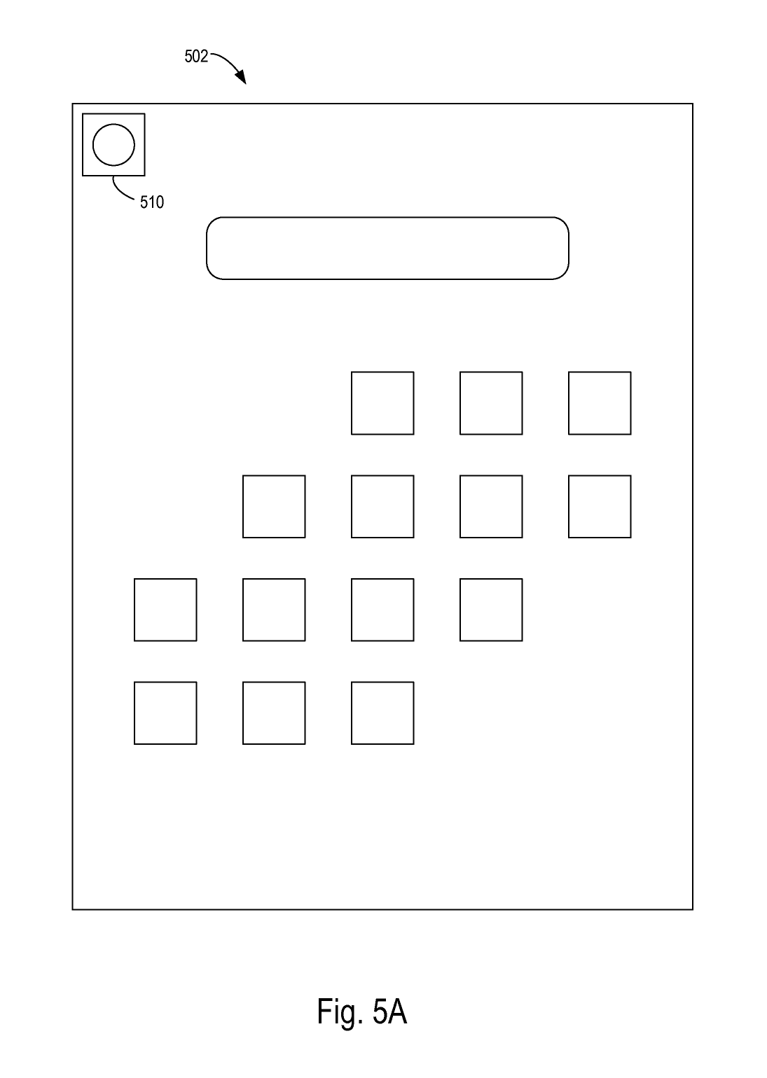

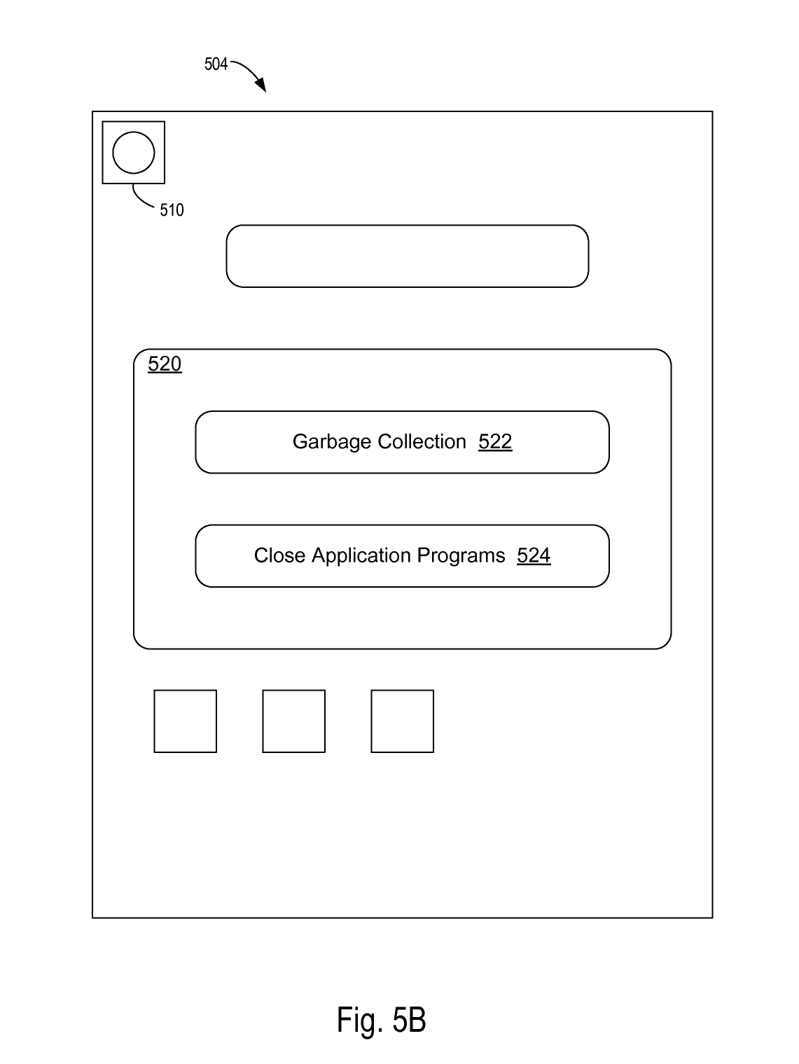

FIGS. 5A-5B are exemplary user interfaces in accordance with some embodiments.

FIG. 5A illustrates an exemplary user interface 500 of a web browser that includes a display of a web page. The exemplary user interface 500 is typically displayed on a touch-sensitive display (also called herein “touch screen”).

The user interface 500 includes a user interface element 510. In some embodiments, the user interface element 510 indicates that a system reaction time does not meet a particular criterion (e.g., the system reaction time exceeds a maximum acceptable reaction time). For example, in some embodiments, the user interface element 510 is displayed in response to determining that the system reaction time does not meet the particular criterion. In some other embodiments, the user interface element 510 is visually distinguished (e.g., changes colors and/or shapes) in response to determining that the system reaction time does not meet the particular criterion. In some embodiments, the user interface element 510 is not displayed while the system reaction time meets the particular criterion.

In some embodiments, a user input is detected at a location on the touch-sensitive display that corresponds to the user interface element 510. In some embodiments, in response to detecting a user input at a location on the touch-sensitive display that corresponds to the user interface element 510, a cleaning process is performed.

In some embodiments, in response to detecting a user input at a location on the touch-sensitive display that corresponds to the user interface element 510, an exemplary user interface 504 illustrated in FIG. 5B is displayed (typically prior to performing the cleaning process).

In FIG. 504, the user interface 504 includes a display of a user input interface 520. In some embodiments, the user input interface 520 includes a user interface element 522, which, when selected (e.g., by a user input on the touch-sensitive display), initiates deleting at least a subset of buffered data. In some embodiments, the user input interface 520 includes a user interface element 524, which, when selected (e.g., by a user input on the touch-sensitive display), initiates closing a plurality of application programs that are currently running or otherwise taking up resources in a background of a portable electronic device. In some embodiments, the user input interface 520 ceases to be displayed on the touch-sensitive display in accordance with a determination that at least one of the user interface elements 522 and 524. In some embodiments, the user input interface 520 includes one or more other user interface elements. For example, in some embodiments, the user input interface 520 includes a user interface element (e.g., labeled “start”), which, when selected, initiates the selected operations (e.g., garbage collection and/or closing application programs).

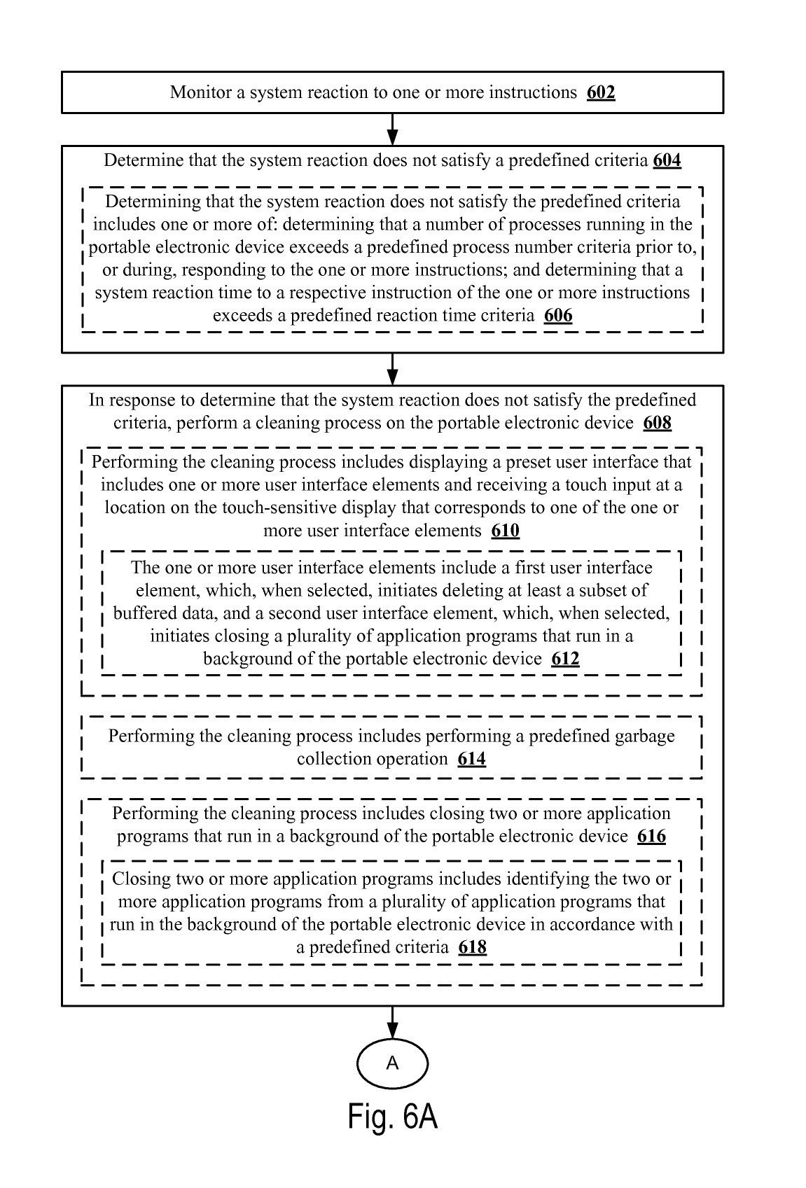

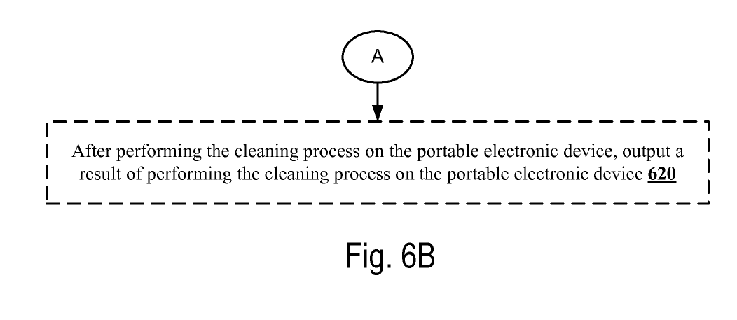

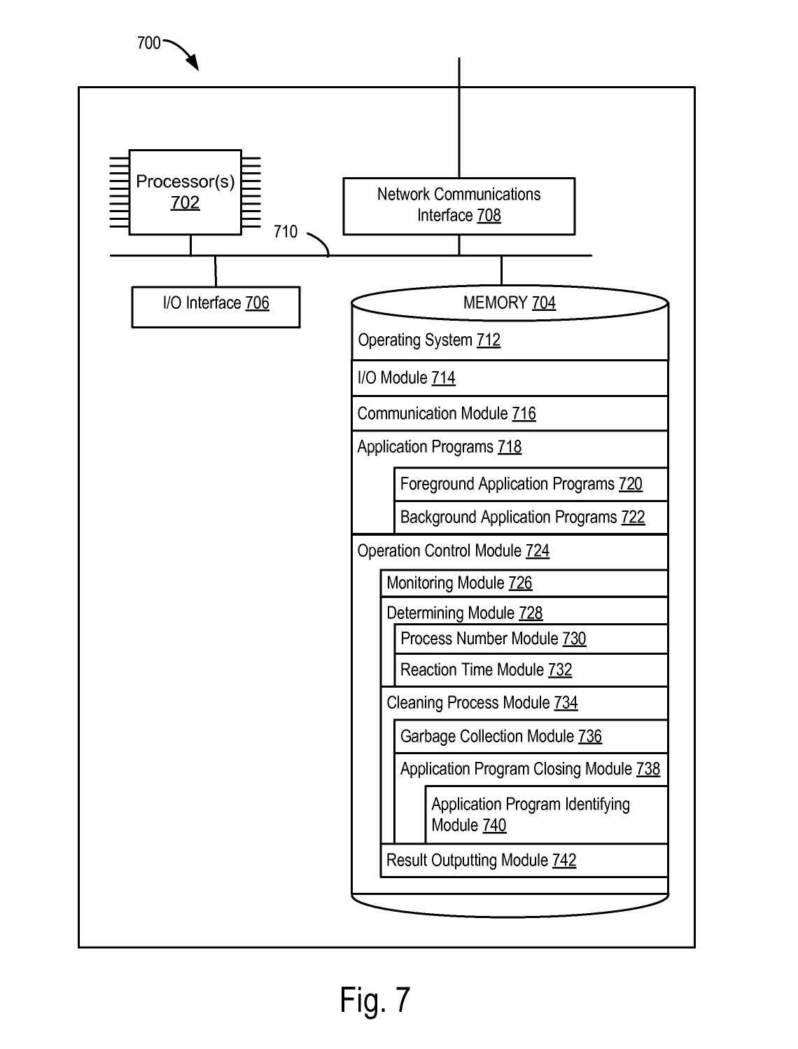

FIGS. 6A-6B are flow charts of an exemplary method 600 for performing a cleaning process on a portable electronic device in accordance with some embodiments. The method 600 is performed by a portable electronic device (e.g., the system 700 illustrated in FIG. 7). The portable electronic device includes a touch-sensitive display.

The device monitors (602) a system reaction to one or more instructions. In some embodiments, the one or more instructions correspond to a user input. In some embodiments, the one or more instructions are generated by a monitoring module 722 (FIG. 7). For example, in some embodiments, the device monitors a time interval between a time when a user input is received and a time when a corresponding action is taken (e.g., displaying or updating a user interface, launching an application, etc.). In some embodiments, the device automatically monitors the system reaction to one or more instructions (e.g., the device monitors the system reaction to one or more instructions independent of a user input).

The device determines (604) that the system reaction does not satisfy predefined criteria. For example, in some embodiments, the device determines that the time interval between the time when the user input is received and the time when the corresponding action is taken exceeds a predefined reaction time criterion (e.g., 0.5 second, 1 second, etc.).

In some embodiments, determining that the system reaction does not satisfy the predefined criteria includes (606) displaying a preset user interface that includes displaying one or more user interface elements (e.g., the user input interface 520 with user interface elements 522 and 524, FIG. 5B) and receiving a touch input at a location on the touch-sensitive display that corresponds to one of the one or more user interface elements.

In response to determining that the system reaction does not satisfy the predefined criteria, the device performs (608) a cleaning process on the portable electronic device. For example, in some embodiments, the device removes at least a subset of buffered data (typically “garbage” as described in detail below) and/or closes one or more application programs.

In some embodiments, the one or more user interface elements include (610) a first user interface element (e.g., the user interface element 522, FIG. 5B), which, when selected, initiates deleting at least a subset of buffered data, and a second user interface element (e.g., the user interface element 524, FIG. 5B), which, when selected, initiates closing a plurality of application programs that run in a background of the portable electronic device.

In some embodiments, determining that the system reaction does not satisfy the predefined criteria includes (612) one or more of: determining that a number of processes running in the portable electronic device exceeds predefined process number criteria prior to, or during, responding to the one or more instructions; and determining that a system reaction time to a respective instruction of the one or more instructions exceeds predefined reaction time criteria. For example, in some embodiments, the device determines that the system reaction does not satisfy the predefined criteria in accordance with a determination that a number of processes running in the device exceeds a predefined number of processes. In some embodiments, the device determines that the system reaction does not satisfy the predefined criteria in accordance with a determination that the reaction time exceeds a predefined reaction time criterion. In some embodiments, the device determines that the system reaction does not satisfy the predefined criteria in accordance with a determination that there are more than a predetermined number of communication channels open on the mobile device. In some embodiments, the device determines that the system reaction does not satisfy the predefined criteria in accordance with a determination that there are more than a predetermined number of processes that have been suspended on the mobile device. In some embodiments, the device determines that the system reaction does not satisfy the predefined criteria in accordance with a determination that there are more than a predetermined number of ghost processes on the mobile device.

In some embodiments, performing the cleaning process includes (614) performing a predefined garbage collection operation. As used herein, garbage refers to data that has not been used (e.g., accessed) by one or more application programs for more than a predefined time interval. To be more specific, garbage refers to buffered data that has not been used by one or more application programs for more than a predefined time interval. In some embodiments, garbage refers to data that is not accessible by any of active application programs (e.g., in the foreground or in the background). A garbage collection operation refers to removing and/or deleting garbage. In some embodiments, a garbage collection operation refers to releasing memory currently occupied by garbage to be used for storing different data.

In some embodiments, performing the predefined garbage collection operation includes invoking a command for a garbage collection operation. For example, in some embodiments, an operating system of the device includes a predefined command for the garbage collection operation.

In some embodiments, performing the cleaning process includes (616) closing two or more application programs that run in a background of the portable electronic device. In some embodiments, closing the two or more application programs includes shutting down the two or more application programs so that the two or more application programs no longer run in the foreground or background. In some embodiments, closing the plurality of application programs includes invoking a command to close a respective application program in the background of the portable electronic device.

In some embodiments, closing two or more application programs includes (618) identifying the two or more application programs (e.g., all application programs that have not been actively accessed by the user for a predetermined amount of time) from a plurality of application programs that run in the background of the portable electronic device in accordance with predefined application program selection criteria.

In some embodiments, identifying the two or more application programs from a plurality of application programs that run in the background of the portable electronic device in accordance with the predefined criteria includes identifying two or more application programs, of the plurality of application programs, that have not been used for more than a predefined duration (e.g., 1 hour, 8 hours, 24 hours, etc.). In some embodiments, identifying the two or more application programs from a plurality of application programs that run in the background of the portable electronic device in accordance with the predefined criteria includes excluding one or more most recently used application programs of the plurality of application programs. In some embodiments, identifying the two or more application programs from a plurality of application programs that run in the background of the portable electronic device in accordance with the predefined criteria includes excluding one or more most frequently used application programs of the plurality of application programs.

In some embodiments, closing two or more application programs includes closing all application programs that currently run on the portable electronic device other than one or more application programs that currently run in the foreground of the portable electronic device.

In some embodiments, after performing the cleaning process on the portable electronic device, the device outputs (620) a result of performing the cleaning process on the portable electronic device. For example, in some embodiments, the device changes a color or shape of a user interface element (e.g., the user interface element 510 in FIG. 5B). In some embodiments, the device outputs an audible signal indicating a completion of the cleaning process. In some embodiments, the device displays a message that indicates a completion of the cleaning process. In some embodiments, the device outputs a message that indicates details of the cleaning process. For example the message may include a number of application programs that have been closed and/or an amount of garbage (e.g., in kilobytes or megabytes) that have been deleted.

FIG. 7 is a block diagram of a system 700 for implementing the method of performing a cleaning process, as described above, in accordance with some embodiments. In some embodiments, the system 702 is one of: mobile device, handheld computer, and tablet computer.

As shown in FIG. 7, the system 700 includes one or more processing units (also called herein “processors”) 702, memory 704, an input/output (I/O) interface 706, and a network communications interface 708. These components communicate with one another over one or more communication buses or signal lines 710. In some embodiments, the memory 704, or the computer readable storage media of memory 704, stores programs, modules, instructions, and data structures including all or a subset of: an operating system 712, an I/O module 714, a communication module 716, application programs 718, and an operation control module 724. The one or more processors 702 are coupled to the memory 704 and operable to execute these programs, modules, and instructions, and reads/writes from/to the data structures.

In some embodiments, the processing units 702 include one or more microprocessors, such as a single core or multi-core microprocessor. In some embodiments, the processing units 702 include one or more general purpose processors. In some embodiments, the processing units 702 include one or more special purpose processors.

In some embodiments, the memory 704 includes high-speed random access memory, such as DRAM, SRAM, DDR RAM or other random access solid state memory devices. In some embodiments the memory 704 includes non-volatile memory, such as one or more magnetic disk storage devices, optical disk storage devices, flash memory devices, or other non-volatile solid state storage devices. In some embodiments, the memory 704 includes one or more storage devices remotely located from the processing units 702. The memory 704, or alternately the non-volatile memory device(s) within the memory 704, comprises a computer readable storage medium.

In some embodiments, the I/O interface 706 couples one or more input/output devices, such as displays, a keyboards, touch screens, speakers, and microphones, to the I/O module 714 of the system 700. The I/O interface 706, in conjunction with the I/O module 714, receive user inputs (e.g., voice input, keyboard inputs, touch inputs, etc.) and process them accordingly. The I/O interface 706 and the I/O module 714 also present outputs (e.g., sounds, images, text, etc.) to the user according to various program instructions implemented on the system 700.

In some embodiments, the network communications interface 708 includes wired communication port(s) and/or wireless transmission and reception circuitry. The wired communication port(s) receive and send communication signals via one or more wired interfaces, e.g., Ethernet, Universal Serial Bus (USB), FIREWIRE, etc. The wireless circuitry receives and sends RF signals and/or optical signals from/to communications networks and other communications devices. The wireless communications may use any of a plurality of communications standards, protocols and technologies, such as GSM, EDGE, CDMA, TDMA, Bluetooth, Wi-Fi, VoIP, Wi-MAX, or any other suitable communication protocol. The network communications interface 708 enables communication between the system 700 with networks, such as the Internet, an intranet and/or a wireless network, such as a cellular telephone network, a wireless local area network (LAN) and/or a metropolitan area network (MAN), and other devices. The communications module 716 facilitates communications between the system 700 and other devices (e.g., the first client device and the second client device) over the network communications interface 708.

In some embodiments, the operating system 702 (e.g., Darwin, RTXC, LINUX, UNIX, OS X, WINDOWS, or an embedded operating system such as VxWorks) includes various software components and/or drivers for controlling and managing general system tasks (e.g., memory management, storage device control, power management, etc.) and facilitates communications between various hardware, firmware, and software components.

In some embodiments, the system 700 is implemented on a portable electronic device (e.g., a smart phone, a mobile phone, a tablet computer, etc.). It should be noted that the system 700 is only one example, and that the system 700 may have more or fewer components than shown, may combine two or more components, or may have a different configuration or arrangement of the components. The various components shown in FIG. 7 may be implemented in hardware, software, firmware, including one or more signal processing and/or application specific integrated circuits, or a combination of thereof.

In FIG. 7, the application programs 718 stored in the memory 704 include one or more foreground application programs 720 and background application programs 722. A foreground application program typically refers to an application program a user interface of which is currently displayed on a display of the system 700. For example, in FIG. 5A, when a web browser displays a web page on a touch-sensitive display, the web browser is a foreground application program. In comparison, a background application program typically refers to a currently running application program a user interface of which is not currently displayed on the display of the system. A background application program is distinct from a closed application program that is not running on the system. For example, when the system stores a calendar application program but does not run the calendar application program, the calendar application is deemed to be closed. In comparison, when the system runs the calendar application program but does not display a user interface of the calendar application program, the calendar application program is deemed to be running in the background. Typically, an application program is deemed to be running when at least one process associated with the application program is being executed by one or more processors 702 of the system 700. In some embodiments, the application program is deemed to be running when at least one process associated with the application program is executed at one or more predefined intervals independent of a user input by one or more processors 702 of the system 700.

As shown in FIG. 7, the system 700 stores the operation control module 724 in the memory 704. In some embodiments, the operation control module 724 further includes the followings sub-modules, or a subset or superset thereof: a monitoring module 726, a determining module 728, a cleaning process module 734, and a result outputting module 742. In some embodiments, the determining module 728 includes one or more of: a process number module 730 and a reaction time module 732. In some embodiments, the cleaning process module 734 includes one or more of: a garbage collection module 736 and an application program closing module 738. In some embodiments, the application program closing module 738 includes an application program identifying module 740. In some embodiments, the application program closing module 738 has access to the application programs 718 (e.g., the background application programs 722) stored in the memory 704 and/or one or more predefined commands to close the background application programs 722 in the operating system 712. In some embodiments, the operation control module 724 optionally includes one or more other modules to provide other related functionalities described herein. Details on the structures, functions, and interactions of the operation control module 724 are provided with respect to FIGS. 1-4, 5A-5B and 6A-6B and accompanying descriptions.

It should be noted that in the device for processing an application program in the abovementioned embodiments, illustration is only made according to the division of the abovementioned functional modules, and in practical use, the abovementioned functions can be assigned to be implemented by different functional modules as required, i.e., dividing the internal structure of the device into different functional modules to implement all or some of the above-described functions.

In addition, the device for processing an application program and the method for processing an application program provided in the abovementioned embodiments belong to the same concept, and the specific implementation processes thereof can be made reference to the method embodiments in detail, which will not be described here for brevity.

The sequence numbers of the abovementioned embodiments of the present invention are merely for description purposes, and do not represent the advantages or disadvantages of the embodiments.

A person skilled in the art can understand that all or some of the steps of the abovementioned embodiments can be implemented by hardware, and can also be implemented by a program instructing related hardware, and the program can be stored in a computer readable storage medium, and the abovementioned storage medium can be a read-only memory, a magnetic disk, or an optical disk, and so on.

What are described above are merely exemplary embodiments of the present invention and are not used to limit the scope of claims, and any modifications, equivalent substitutions, improvements and so on made within the spirit and principles of the present invention shall all be deemed to be within the scope of the claims.

What is claimed is:

1. A method performed by a portable electronic device with a touch-sensitive display, the method comprising:
monitoring a system reaction to one or more instructions;
determining that the system reaction does not satisfy predefined criteria; and,
in response to determine that the system reaction does not satisfy the predefined criteria, performing a cleaning process on the portable electronic device.

2. The method of claim 1, wherein determining that the system reaction does not satisfy the predefined criteria includes displaying a preset user interface that includes one or more user interface elements and receiving a touch input at a location on the touch-sensitive display that corresponds to one of the one or more user interface elements.

3. The method of claim 2, wherein the one or more user interface elements include a first user interface element, which, when selected, initiates deleting at least a subset of buffered data, and a second user interface element, which, when selected, initiates closing a plurality of application programs that run in a background of the portable electronic device.

4. The method of claim 1, wherein determining that the system reaction does not satisfy the predefined criteria includes one or more of:
determining that a number of processes running in the portable electronic device exceeds predefined process number criteria prior to, or during, responding to the one or more instructions; and
determining that a system reaction time to a respective instruction of the one or more instructions exceeds predefined reaction time criteria.

5. The method of claim 1, wherein performing the cleaning process includes performing a predefined garbage collection operation.

6. The method of claim 1, wherein performing the cleaning process includes closing two or more application programs that run in a background of the portable electronic device.

7. The method of claim 6, wherein closing two or more application programs includes identifying the two or more application programs from a plurality of application programs that run in the background of the portable electronic device in accordance with predefined application program selection criteria.

8. The method of claim 1, including:
after performing the cleaning process on the portable electronic device, outputting a result of performing the cleaning process on the portable electronic device.

9. A portable electronic device, comprising:
one or more processors;
a touch-sensitive display;
memory; and
one or more program modules stored in the memory and to be executed by the one or more processors, the one or more program modules further including:
module for monitoring a system reaction to one or more instructions;
module for determining that the system reaction does not satisfy predefined criteria; and
module for performing a cleaning process on the portable electronic device in response to determine that the system reaction does not satisfy the predefined criteria.

10. The device of claim 9, wherein the module for determining that the system reaction does not satisfy the predefined criteria includes module for displaying a preset user interface that includes one or more user interface elements and receiving a touch input at a location on the touch-sensitive display that corresponds to one of the one or more user interface elements.

11. The device of claim 10, wherein the one or more user interface elements include a first user interface element, which, when selected, initiates deleting at least a subset of buffered data, and a second user interface element, which, when selected, initiates closing a plurality of application programs that run in a background of the portable electronic device.

12. The device of claim 9, wherein the module for determining that the system reaction does not satisfy the predefined criteria includes one or more of:
module for determining that a number of processes running in the portable electronic device exceeds predefined process number criteria prior to, or during, responding to the one or more instructions; and
module determining that a system reaction time to a respective instruction of the one or more instructions exceeds predefined reaction time criteria.

13. The device of claim 9, wherein the module for performing the cleaning process includes module for performing a predefined garbage collection operation.

14. The device of claim 9, wherein the module for performing the cleaning process includes module for closing two or more application programs that run in a background of the portable electronic device.

15. The device of claim 14, wherein the module for closing two or more application programs includes module for identifying the two or more application programs from a plurality of application programs that run in the background of the portable electronic device in accordance with predefined application program selection criteria.

16. The device of claim 9, wherein the one or more program modules further include:
module for outputting a result of performing the cleaning process on the portable electronic device after performing the cleaning process on the portable electronic device.

17. A non-transitory computer readable storage medium storing one or more program modules for execution by one or more processors of a portable electronic device, the one or more program modules including instructions for:
monitoring a system reaction to one or more instructions;
determining that the system reaction does not satisfy predefined criteria; and,
in response to determine that the system reaction does not satisfy the predefined criteria, performing a cleaning process on the portable electronic device.
